(19) United States
(12) Patent Application Publication
(10) Pub. No.: US 2015/0207352 A1
(43) Pub. Date: Jul. 23, 2015

(54) CHARGING STATION AND SYSTEM

(71) Applicant: AITICO OY, Lahti (FI)

(72) Inventor: Evgeny Lykov, Metsakyla (FI)

(21) Appl. No.: 14/424,594

(22) PCT Filed: Aug. 28, 2012
(86) PCT No.: PCT/FI2012/050817

§ 371 Date: Feb. 27, 2015

(51) Int. Cl. H02J 7/00

(52) U.S. Cl. CPC H02J 7/0044; H02J 7/007; H02J 7/0047

(57) ABSTRACT

A charging station for charging at least one mobile terminal removably coupled to at least one charging location of the charging station includes a charging interface for providing current to a battery of the at least one mobile terminal, locking mechanism configured to removably locking the at least one mobile terminal with the charging station, I/O elements configured to receive input including release information for releasing the at least mobile terminal and processing unit configured to verify if the inputted release information corresponds to legitimate release information available for the charging station, and if the verification indicates that the inputted release information corresponds to the legitimate release information, to deliver a release signal to the locking mechanism for releasing the locking of the at least one mobile terminal with the charging station. A charging system for providing a charging for at least one mobile terminal is also described.

### TECHNICAL FIELD

The invention concerns in general the technical field of charging of electronic devices. Especially the invention concerns enabling delivery of electronic devices for use from a charging station.

### BACKGROUND OF THE INVENTION

Mobile terminals have become more and more common. The current trend is that users of the mobile terminals are consuming more and more digital content by means of the mobile terminals. Another trend is that public places, such as cafes and libraries, have started offering mobile terminals for borrow or rental in their premises. For example, a customer in a café may want to read a newspaper by means of an electronic device while drinking a cup of coffee. In order to achieve customer satisfaction the publicly available mobile terminals shall operate in such a manner that the customer can “just” pick-up and use the device but not spend up time in enabling the use of it.

An important issue for providing the mobile terminals for use in public places is that the terminals are properly charged before anyone starts using them. Additionally, as the mobile terminals are typically quite expensive there shall be arranged some kind of mechanism to prevent a theft of the devices, especially when the devices are offered for public use. However, the drawback of the known charging systems is that they only provide the charging capability, but not any limitation to the accessibility and use of the devices.

Further, as the devices are offered in public places there is typically need for putting more than one device available. This means that the charging shall also be arranged to more than one device at a time as well as the mechanism to prevent the free access to the terminals. Additionally, it would be advantageous if the service provider could acquire the whole system i.e. the charging station and the mobile terminals from the seller as a turnkey solution. Added value could also be achieved if the charging station can be coupled into the other systems of the service provider so that e.g. the prevention of theft of the mobile terminals could be gained at least partly by means other systems of the service provider. At the same time it would be advantageous that the delivery of the mobile terminals is arranged so that the need for personnel in the delivery process is minimized.

In order to provide a turnkey solution for the service providers the charging station may also comprise further features such as management of one or more devices simultaneously as well as providing wireless network coverage for the devices.

### SUMMARY OF THE INVENTION

An objective of the invention is to present a charging station and a system for enabling a charging of at least one mobile terminal and at the same time limiting the accessibility to the mobile terminals. Another objective of the invention is that the charging station and the system provide a turnkey solution for offering mobile terminals for use.

The objects of the invention are reached by a charging station and a system as defined by the respective independent claims.

According to a first aspect of the invention, a charging station for charging at least one mobile terminal removably coupled to at least one charging location of the charging station is provided, wherein the charging station comprises charging interface within the charging location configured to provide current to a battery of the at least one mobile terminal, locking mechanism configured to removably locking the at least one mobile terminal with the charging station, I/O means configured to receive input comprising release information for releasing the at least mobile terminal from the charging station, processing unit configured to verify if the inputted release information corresponds to legitimate release information available for the charging station, and if the verification indicates that the inputted release information corresponds to the legitimate release information, to deliver a release signal to the locking mechanism for releasing the locking of the at least one mobile terminal with the charging station. The legitimate release information available for the charging station may be stored in a memory unit.

The locking of the at least one mobile terminal may be arranged to be achieved mechanically.

The charging station may further comprise a signal path with the removably locked mobile terminal. An electrical locking of the at least one mobile terminal may be arranged by means of the signal path. Furthermore, at least one of the following information may be exchanged over the signal path: acknowledgement signal for indicating a legitimate release of the mobile terminal, activation signal for activating the operation of the mobile terminal, status signal.

The charging station may further comprise alarm means configured to trigger an alarm if the mobile terminal is removed in an unauthorized manner from the charging station.

The charging station may further comprise a wireless modem for establishing a wireless communication channel with the at least one mobile terminal. The charging station may be configured to monitor at least one of the following: activity of a wireless channel between the charging station and at least one mobile terminal, signal strength of a wireless channel. Further, the charging station may be configured to trigger an alarm if a predetermined condition is not met as regards to the activity of a wireless channel between the charging station and at least one mobile terminal or signal strength of a wireless channel.

The charging station may further comprise a wired or wireless modem for coupling the charging station to an external entity with a corresponding communication technique.

The charging station may further comprise at least one voltage meter for measuring the charging of a battery of at least one mobile terminal either continuously or in response to an input of legitimate release code. The processing unit may be configured to receive voltage levels of the batteries of at least two mobile terminals, to compare the voltage levels and in response to the comparison, the processing unit of the charging station may be configured to define the mobile terminal in which the voltage level of the battery is the highest. The processing unit may be configured to deliver a release signal to the locking mechanism of a charging location charging the mobile terminal having the battery with the highest voltage level.

The charging station may further comprise indication means for indicating the at least one released mobile terminal.

According to a second aspect of the invention, a charging system for providing a charging of at least one mobile terminal in the system is provided, wherein the system comprises a charging station providing a charging location for at least one mobile terminal and removably locking the at least one mobile terminal thereto and the charging station further comprises I/O means for inputting information by a user. The charging system further comprises an information system for creating at least part of the release information for releasing the at least one mobile terminal from the charging station. Within the system the charging station and the information system are arranged to be coupled either directly or indirectly over an external entity for enabling the communication between the charging station and the information system, wherein the release information created in the information system is arranged to be available for the charging station for verifying if the inputted information by the user matches with the created release information, and if the verification indicates that the inputted information corresponds to the created release information, the system is configured to deliver a release signal to the locking mechanism of the charging station for releasing the at least one mobile terminal from the charging station.

Within the charging system the created release information may either be delivered to the charging station for storing or be stored in the information system.

Within the charging system the charging station may be configured to inquiry the stored release information from the information system in response to a receipt of information inputted by the user by I/O means of the charging station.

The information system within the charging system may be configured to store information on user access rights to release at least one mobile station from the charging station.

The exemplary embodiments of the invention presented in this patent application are not to be interpreted to pose limitations to the applicability of the appended claims. The verb “to comprise” is used in this patent application as an open limitation that does not exclude the existence of also un-recited features. The features recited in depending claims are mutually freely combinable unless otherwise explicitly stated.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF DRAWINGS

FIGS. 1a-1b illustrate embodiments of the charging station according to the invention,

FIG. 2 illustrates an embodiment of the charging station according to the invention,

FIG. 3 illustrates an example of electronics of the charging station,

FIGS. 4a-4b illustrate an example of a locking mechanism according to the invention,

FIGS. 5a-5b illustrate another example of a locking arrangement according to the invention, and

FIG. 6 illustrates an example of the charging system according to the invention.

### DETAILED DESCRIPTION OF THE INVENTION AND ITS ADVANTAGEOUS EMBODIMENTS

The invention relates to a charging station which is configured to charge at least one device at a time and which at the same time provides a way to lock the device to the charging station in one way or another. The term ‘lock’ shall be understood in a broad sense covering also implementations in which the operation of the device is prevented by software means if the device is removed from the charging station in a wrong way. The device can be a wireless mobile terminal covering mobile phones, tablet computers and laptops among other similar.

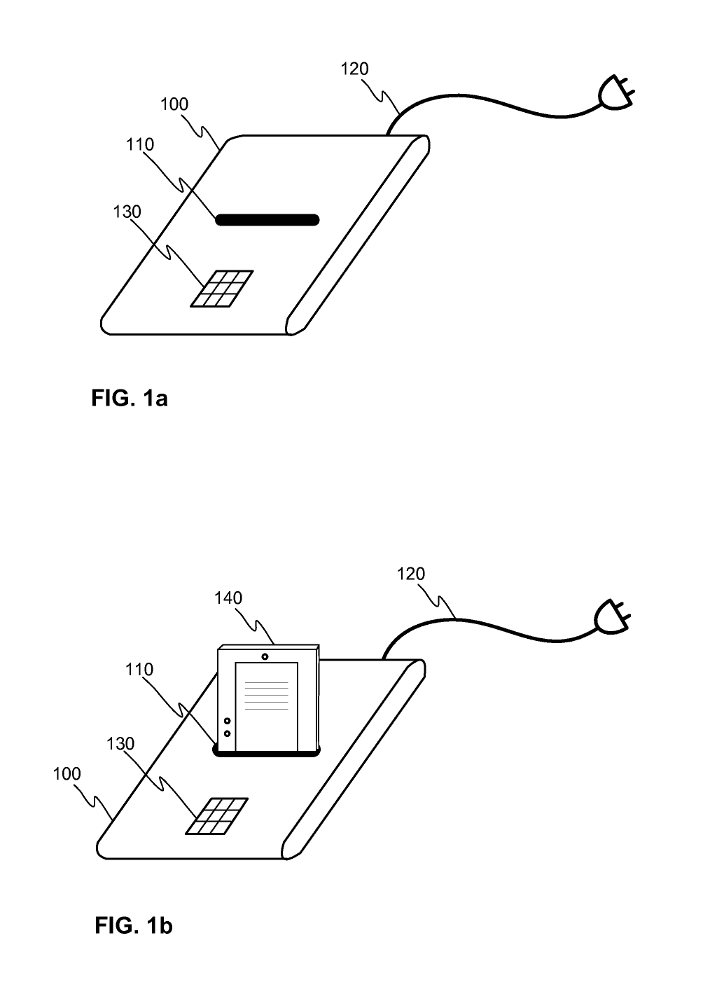

FIG. 1a illustrates an example of the charging station 100 according to an embodiment of the invention. The charging station 100 as illustrated in FIG. 1 comprises one location 110 into which mobile terminal 140 can be positioned for charging. According to the embodiment the location 110 is an opening into which the mobile terminal 140 can be slid. Any other type of structures can also be implemented within the limits of the invention. For example, any type of cradle can be implemented on the charging station 100 so that the mobile terminal 140 can be removably placed on the cradle for charging. The location into which the mobile terminal 140 is to be placed for charging comprises at least an electrical charging interface so that the electricity for charging the battery of the mobile terminal 140 can be conveyed to the mobile terminal 140. In its simplest form the charging interface is an electrical contact, which is configured to touch the corresponding contact in the mobile terminal 140 when the mobile terminal 140 is removably mounted into the charging location 110, such as a cradle.

FIG. 1b illustrates the arrangement of FIG. 1a when the mobile terminal 140 is mounted into the charging position.

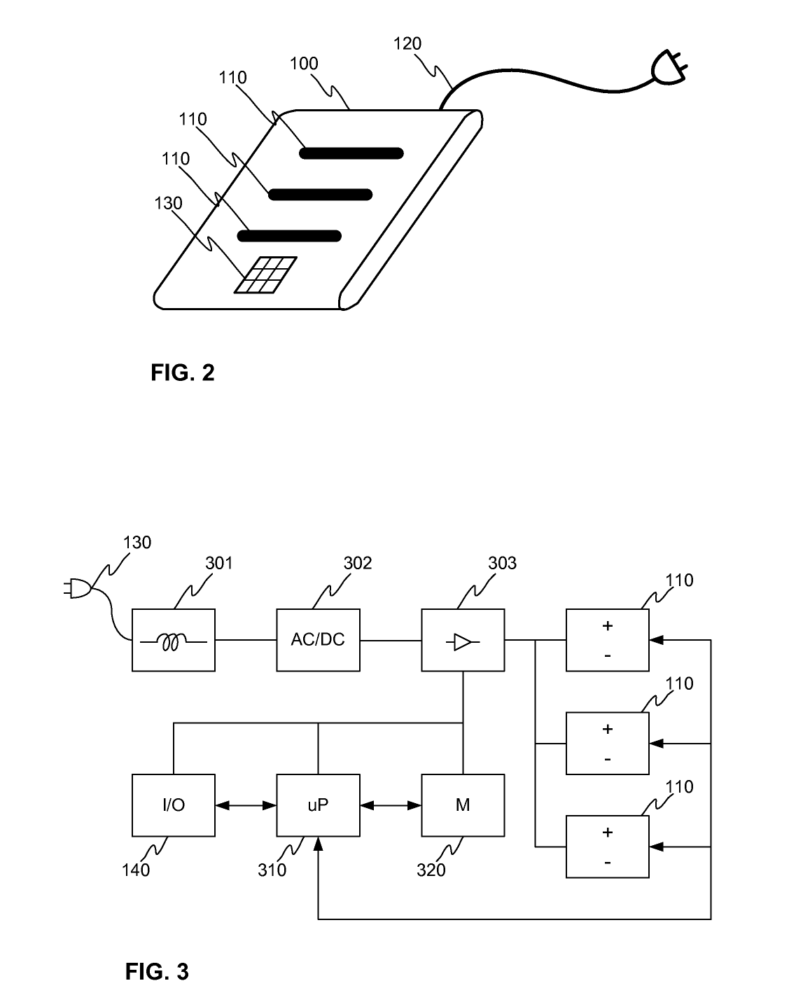

FIG. 2 illustrates an example of a charging station 100 which is equipped with multiple charging locations 110 into which multiple mobile terminals 140 can simultaneously be mounted for charging.

The charging station 100, as illustrated in FIGS. 1a, 1b and 2, is configured to receive the electrical power via a cable 120 when plugged to the mains current. FIG. 3 illustrates a simplified diagram of the main electrical elements in the charging station in order to enable the charging. As the charging station 100 receives alternating current (AC) from the mains, the voltage level may first be transformed to an appropriate level for the devices to be charged by means of a transformer 301. Typically, the charging is performed by means of direct current (DC), which means that the output AC power from the transformer is configured to be converted to DC power by means of AC/DC converter 302. From the AC/DC converted the power is conveyed to a voltage regulator 303, which is designed to automatically maintain a constant voltage level for the devices to be charged. Furthermore, the circuit may comprise surge protector (not illustrated in FIG. 3) for preventing power surges from the mains to destroy the circuit as well as current limiters (not illustrated in FIG. 3) for preventing any excessive current to reach the mobile terminal that is charged. Finally, the power is adapted to the devices to be charged and the voltage is arranged to the locations in which the devices are configured to be charged. The connectors in the locations 110 into which the mobile terminal 140 is to be placed for charging are connected either directly or indirectly to the electric circuit implementing the power matching for the mobile terminal 140. The number of the coupling locations may vary according to the need.

According to an embodiment of the invention the charging station 100 provides locking means for locking the mobile terminal 140 with the charging station 100. The locking means may e.g. comprise mechanical elements, which are configured to lock the mobile terminal 140 to the charging station 100 when the mobile terminal 140 is placed to the charging location 110. In order to release the mobile terminal 140 from the charging station 100 the person wanting to use the terminal 140 needs to perform a predefined user action. An example of the user action is that the user gives a predetermined input with input/output (I/O) means 130 of the charging station 100. The input information may be taken to a processing unit 310 of the charging station 100. The processing unit 310 is configured to compare if the user input matches with release information available to the processing unit either directly or indirectly. The release information may be stored in an internal memory unit 320 of the charging station 100 or alternatively the release information may be retrieved from an external entity if the charging station 100 is equipped with communication means. If the comparison indicates that the user input matches with release information, the processing unit 310 is configured to create and deliver a release signal to the locking means of the charging station 100.

The I/O means 130 may comprise a keyboard, a display, a touch screen, a magnetic card reader, a camera, a bar code reader, a finger-print detector, a microphone, a loudspeaker, a light-source, NFC (Near Field Communication) reader or any combination of these. The I/O means 130 may be coupled to the charging station 100 either directly or indirectly by utilizing e.g. wired or wireless communication technologies. The processing unit 310 may comprise one or more processors arranged to communicate with at least other elements of the charging station 100. The processing unit 310 is configured to execute portions of computer program code stored in the memory unit 320 in order to at least partly control the operation of the charging station 100. The controlling of the operation of the charging station 100 may comprise composing and delivery of instructions to any other element of the charging station 100. The memory unit 320 may comprise one or more memory chips comprising necessary amount of memory capacity. The memory chips can be e.g. RAM and/or ROM type(s). The processing unit 310 may comprise internal memory elements to be used for storing information either permanently or temporarily. Alternatively or in addition, the processing unit 310 may utilize any elements of the memory unit 320 for the same.

The release information, and thus also the user input, can be a character string containing a predetermined number of digits. The user input can also be a gesture defined by the service provider in advance. Additionally, the user input can be a tone sample or a finger-print. Alternatively or in addition, the user can input a magnetic card into the charging station 100 for releasing a mobile terminal 100 from the charging station 100. In some of the embodiments as described the charging station 100 is equipped with a reader, which is configured to receive information as inputted (e.g. magnetic card reader or finger-print reader).

In such an embodiment in which the charging station 100 is configured to charge multiple mobile terminals 140 simultaneously there may exist only one I/O means 130 for inputting information in order to release any of the mobile terminals 140. Alternatively, the charging station 100 may comprise dedicated I/O means for each of the charging locations 110. If there exists only one I/O means 130 for inputting information in order to release any of the terminals, it may be arranged so that when a user gives a correct code, one of the mobile terminals 140 residing in the charging station is released. For example, a light source, such as led, may be arranged for each or the charging locations 110 for indicating which mobile terminal 140 is released. The led may e.g. start blinking. It may also be arranged that the processing unit 310 is configured to monitor the duration of the release and if the mobile terminal 140 is not picked up during a predefined period of time, the mobile terminal 140 may be automatically re-locked i.e. the processing unit 310 is configured to deliver a locking instruction to the locking means. According to some other embodiment of the invention the user may give a character for indicating the mobile terminal, he or she wants to take into use. The code can be given in the same context as the user input for releasing the mobile terminal 140 or separately. The charging station may also prompt the user to indicate the mobile terminal 140 to be released.

According to some embodiment of the invention the charging station 100 is configured to monitor users input attempts for releasing the mobile terminal 140. There may be set up a limit for the number of attempts to input the release information. If no correct code is given, the charging terminal 100 may be configured to give an alarm for preventing any misuse of the system. The monitoring and alarming may be arranged by means of the processing unit 310 executing at least a portion of computer program code stored in the memory unit 320. The alarm can be given by a an alarm means and the alarm can be a sound or an alarm signal delivered to any other entity if the charging station 100 is equipped with wired or wireless communication technologies. Furthermore, the charging station may be configured to deliver instructions to the user through a display or audible signal. The instructions are advantageously stored in the memory unit 320 of the charging station 100.

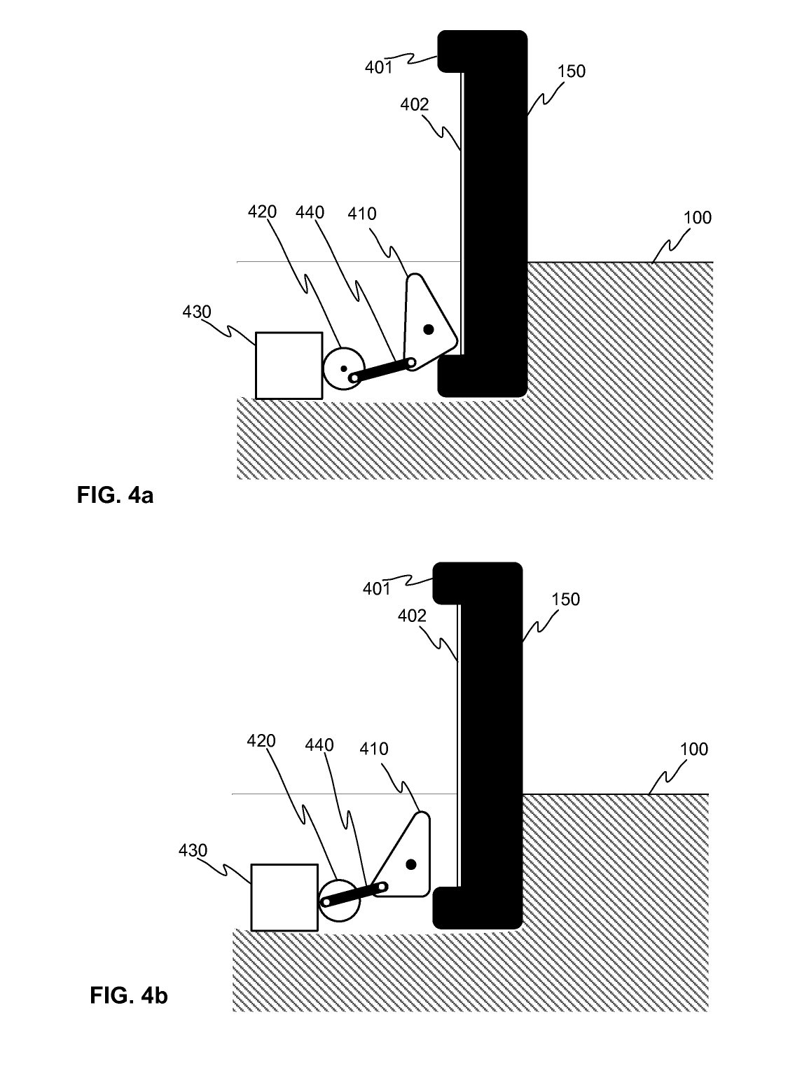

In the following it is discussed the locking mechanism of a mobile terminal 140. Generally speaking any locking mechanism can be applied as long as it locks the mobile terminal 140 to the charging station 100 in a manner that it cannot be released and/or used without a predefined action, such as giving release information in the charging station 100. FIG. 4a illustrates an embodiment of the locking mechanism. The locking mechanism in the embodiment is based on the idea that when the mobile terminal 140 is removably mounted in the charging location 110, the mobile terminal 140 is locked to the charging station 100. More specifically, the appearance of many mobile terminals 140 comprise holes, hollows or protrusions, which provide a good starting point for locking the mobile terminal 140 in the charging station. For example, the mobile terminal 140 as illustrated in FIG. 4a comprises an outer rim 401, which is a protrusion compared to display surface 402. The locking element 410, which in this embodiment is a wedge-shaped pivot element, is configured to lock the mobile terminal 140 into the charging location 110 as illustrated in FIG. 4a, when the mobile terminal 140 is removable placed to the charging location 110. The locking element 410 is configured to position so in the locking position that at least part of it extends so close the display surface 402 that it blocks the removal of the mobile terminal 140 from the charging location 110, because the protrusion of the outer rim hits the locking element 410. The locking element 410 is arranged to be pivoted in such a manner that the locking element 410 can be turned so that the locking element 410 does not prevent the removal of the mobile terminal 140 from the charging location 110. The control of the locking element 410 may be arranged in such a manner that the locking element 410 is coupled to a flywheel 420 powered by an electric motor 430 over a shaft 440. The operation of the motor 430 is controlled by the processing unit 310 in order to instruct the motor 430 to rotate the flywheel 420 a predetermined angle. The angle is defined so that the described movement of the locking element 410 is achieved, when the shaft 440 is arranged to be fixed on the circle of the flywheel 420. For example, it can be arranged that the flywheel 420 has two positions. The first position is such that the locking element 410 locks the mobile terminal 140 into the charging station 100 and the second position is such that the locking element 410 does not block the removal of the mobile terminal 140 from the charging station 100. Even if FIGS. 4a and 4b illustrate the flywheel 420 as a separate element to the motor, in some embodiments the shaft 440 may be directly coupled to the motor 430. The internal elements of the motor 430 may be arranged to convey the force to the shaft so that the flywheel can be rotated. The locking element 410 may also be any other shape than a wedge-shaped element, such as a rod. The rod shaped locking element 410 can be moved towards and away the mobile terminal 140. In case of charging station 100 with multiple charging locations 110 the similar locking mechanism can be arranged to each of the locations 110 as described above. The opening and closing of the mechanisms can be controlled individually or concurrently with any combination of the mechanisms. This can be achieved by means of portions of computer program code executed by the processing unit 310 and as a result delivering a control signal to one or more motors 430 in the locking mechanisms in order to operate the motor for producing a force to cause the locking element 410 to move.

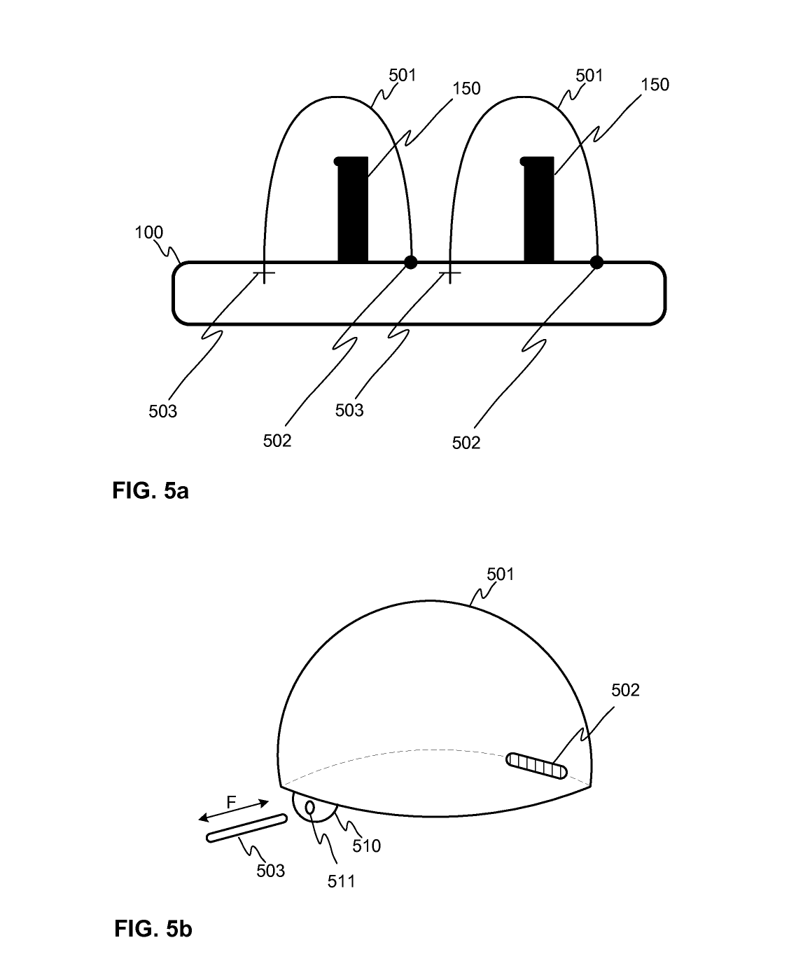

According to some embodiment of the invention the at least one mobile terminal 140 is arranged to be locked to the charging station 100 with a cover as disclosed in FIG. 5a illustrating a cross-sectional view of the charging station 100 according to the invention with two charging locations 110 the mobile terminals 140. The cover 501 can be mounted to the charging station 100 with a hinge 502 so that the cover can be turned over the mobile terminal 140 for removing the mobile terminal 140 from the charging station 100. The cover 501 can be manufactured from e.g. a glass or a plastic. According to an embodiment of the invention the cover 501 is locked to the charging station 100 essentially from the other side of the cover 501 than where the hinge 502 locates. The locking can e.g. be achieved so that there is arranged a protrusion 510 to the cover part as shown in FIG. 5b, which protrusion 510 is configured to fit to a hole on the surface in the charging station 100. The protrusion 510 may comprise a hole 511 into which a pin 503 belonging to the locking mechanism inside the charging station 100 is arranged to be matched. The pin 503 is arranged to be moved to the hole 511 when the cover 501 is closed and thus the cover 501 is locked with a force F created by e.g. a controllable motor. The movement of the pin 503 may be achieved with a force produced by a motor similarly as in the context of the description of FIGS. 4a and 4b. Alternatively or in addition, a spring can be arranged to the locking mechanism for automatically sliding the pin 503 towards the hole 511 in the protrusion 510, when the cover 501 is locked.

According to some further embodiment of the invention the locking can be arranged by means of a strap passing the mobile terminal 140 residing in the charging location 110 so that the mobile terminal 140 cannot be removed without a legitimate action. The locking mechanism of the strap can be similar as described in the context of the cover solution above.

According to some further embodiments of the invention the mobile terminal 140 residing in the charging location 110 may be locked by using mechanism to disable the operation of the mobile terminal if it is removed from the charging station 140 without a legitimate action. This can be achieved so that a signal path is arranged between the charging station 100 and the mobile terminal 140 removably coupled to the charging location 110. The idea is to transfer status information between the charging station 100 and the mobile terminal 140 through the signal path. The signal path can be arranged to the charging interface or separately. If the signal path is arranged to the charging interface, it can be implemented so that one of the pins in a connector coupling the charging station 100 and mobile terminal 140 together is reserved for signaling between the entities. Alternatively or in addition, a separate signal path can be arranged between the entities. For example, the mobile terminal 140 may comprise a separate signaling interface, such as a dedicated connector, which has a counter-interface in the charging station 100. The idea of the signal path is to enable a communication between the charging station 100 and the mobile terminal 140 in order to deliver status information and commands between the entities. For example, it can be arranged so that when a user provides correct release information over the I/O interface 130 of the charging station 100, the charging station 100 may give an acknowledgement signal to the mobile terminal 140 that removal of it from the charging location 110 is legitimate. If the acknowledgement signal is not received by the mobile terminal 140, the mobile terminal 140 is configured to be switched off to such a mode that it cannot be switched on without a predetermined code, for example. This can be arranged by installing an application into the mobile terminal 140, which is configured to monitor, when executed by the processing unit of the mobile terminal 140, an existence of the acknowledgement signal and to communicate with the operating system of the mobile terminal 140 for delivering instructions to e.g. switching on and off the mobile terminal 140. According to another exemplified implementation the mobile terminal 140 is configured to be switched off, when it is coupled to the charging location 110. If the user gives legitimate release information by means of the I/O means of the charging station 100, the charging station 100 may be configured to deliver an activation signal through the signal path to a mobile terminal 140 residing in the charging location 110 and the mobile terminal 140 is thus switched on for use. According to a further embodiment of the invention the monitoring of the legitimate removal of the mobile terminal 140 can be arranged so that a predetermined status signal is arranged to be delivered between the mobile terminal 140 and the charging station 100. For example, when the mobile terminal 140 is coupled to the charging location 110, an alternating digital signal, i.e. the value of the signal varies between ‘0’ and ‘1’ on a predetermined frequency, is started to be delivered between the entities. If a legitimate release information is given by a user, the value of the signal in the signal path is configured to be set e.g. to ‘1’, which indicates that the mobile terminal 140 can be removed from the charging station 100 and the operation of the mobile terminal 140 can be allowed. If, during the alternating digital signal, the mobile terminal 140 is removed from the charging station 100 in an unauthorized way i.e. no appropriate release information is given, the mobile terminal 140 is configured to be switched off and the restart of it may be achieved by means of an activation code. In addition to the prevention of the use of the mobile terminal 140, it may be arranged that the charging station 100 is configured to give an alarm for notifying that somebody is trying to remove or has removed the mobile terminal 140 from the charging station 100 in unauthorized manner, e.g. without a permission to do that.

The charging station 100 according to the invention may also comprise communication means for enabling communication between the charging station 100 and the mobile terminals 140. Alternatively or in addition, the charging station 100 may be arranged to communicate with an external entity. According to an embodiment the charging station 100 may comprise short-range wireless communication means, such as Bluetooth or WLAN modem or both of them. As the mobile terminal 140 comprise corresponding wireless modem a wireless communication channel between the charging station 100 and the mobile terminal 140 can be established. When the mobile terminal 140 is removed from the charging station 100, information can be transmitted between the entities over the wireless communication channel. The charging station 100 equipped with a wireless modem can be configured to operate as a base station for the mobile terminals 140. Additionally, it is possible to arrange so that the charging station 100 is configured to monitor the activity of the radio links. If a radio channel i.e. link is lost, the charging station 100 may be configured to interpret it so that the mobile terminal 140 is taken away from the radio coverage provided by the charging station 100. This can trigger an alarm in order to indicate a possible theft of the mobile terminal 140 from the public place. Similarly, the charging station 100 may be configured to monitor signal strength of the radio link of each of the mobile terminal 140 in use. If the signal strength goes below a predefined level, an alarm can be given. It can be arranged that an alarm can be triggered by the charging station 100 if a predetermined condition is not met as regards to the activity of a wireless channel between the charging station 100 and at least one mobile terminal 140 or signal strength of a wireless channel. Moreover, the alarm can be given by the charging station 100, but also by the mobile terminal 140. In case of an alarm by the mobile terminal 140 the mobile terminal 140 is equipped with means that recognize the lack of radio connection, or a predetermined reduction in signal strength, and in response to that the alarm can be given. Also other actions, such as switching off the mobile terminal, can be arranged in the same context.

Alternatively or in addition, it is possible to arrange some further alarming situations. It may be arranged that the mobile terminal is configured to monitor the charge of the battery. In case of the charge in the battery is running out, when the mobile terminal is in use, the mobile terminal may be arranged to deliver information on this to the charging station 100 over the wireless communication channel. In response to this information it may be arranged that the user may receive another mobile terminal for use, when he or she return the mobile terminal 140 with the outrun battery to the charging station 100. This can be arranged by a software code executed by the processing unit of the charging station 100.

Moreover, the charging station 100 may be coupled to an external entity, such as Internet or a server. The charging station 100 is then equipped with wired or wireless communication means, which enable the coupling and communication to the external entity. For example, wired communication means can be a modem enabling the communication to the Internet. The Internet connection is brought to the modem using a wire, such as Ethernet cable (RJ45). The wireless communication means can be e.g. a 3G or 4G modem, which is either implemented in the charging station 100 or externally coupled to a port implemented in the charging station 100. Such a wireless modem provides connection to a mobile communication network through which it is possible to access e.g. Internet. As the charging station 100 provides the connection to an external entity, it is possible to transfer data between the entities. Further, if the charging station 100 comprises short range wireless modem for establishing the wireless communication channel to the at least one mobile terminal 140, it is possible to configure the charging station 100 to provide access for the mobile terminals 100 to the external entity, such as Internet. The configuration in the charging station 100 can be implemented by applicable electronic components and necessary computer program code.

Furthermore, it may be arranged that the charging station 100 is coupled either directly or indirectly with a server. More precisely, it can be arranged so that the charging station 100 is configured to communicate with the server regularly, when the mobile terminal is in use. For example, in some implementations the mobile terminal may be equipped with a positioning means, such as GPS chip. It can be arranged that the mobile terminal is configured to deliver position information regularly to the server and the server is arranged to maintain the position information. It may also be arranged that every time when the mobile terminal 100 is taken into use, e.g. switched on, the mobile terminal is configured to deliver the position information to the server. For example, if the mobile terminal is stolen, e.g. taken away from the service provider's premises, and it is connected to the internet, the mobile terminal 100 is configured to connect first to the server and deliver its position information defined by the positioning means. In such a manner the stolen mobile terminal can be found. The positioning can be implemented with any known positioning technique, such as GPS or any indoor positioning technique based e.g. on WLAN base stations.

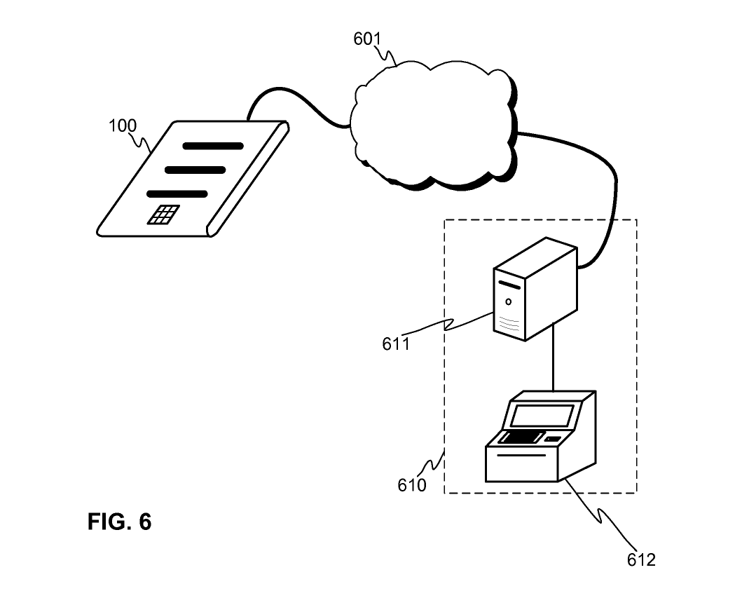

According to an embodiment of the invention a charging station 100 comprising communication means is coupled either directly or indirectly to service provider's information system, such as to a cash register system, and thus forming a charging system. Such an arrangement provides a possibility to create release information for a mobile terminal 140 in the information system. Such an arrangement is illustrated in FIG. 6. The charging station 100 may be coupled to an external entity, such as Internet 601. Similarly, the service provider's information system 610 comprising back-end system 611, such as at least one server and memory units therefor, and a front-end terminal 612, such as cash desk, can be coupled to the Internet. It is also possible that the charging station 100 and the information system 610 are directly coupled in such a manner that information can be exchanged between the entities. Now, when a customer makes his or her purchase and indicates in the cash desk that he or she would like to use a mobile terminal provided by the service provider, e.g. the cafeteria, the information can be delivered to the information system 610 e.g. by means for the front-end terminal 612. The information system 610 is configured, in response to a receipt of the indication of the desire to use a mobile terminal 140, to initiate a creation of release information for a mobile terminal 140. As the creation of the release information is finalized, the release information, such a release code, can be printed on a receipt for the customer. The release information may also be configured to be delivered to the charging station 100 from the information system 610 either directly or indirectly through at least one network node and the created release information i.e. legitimate release information is stored in the charging station 100. Alternatively or in addition the created release information may be stored in the information system 610. The inquiry of the stored information from the charging station 100 can be arranged by means of the communication means. The customer may go and pick up the mobile terminal 140 from the charging station 100 by inserting the release code printed on the receipt. The charging station 100 verifies the inserted release code. If a match is found, the mobile terminal 140 can be released from the charging station 100.

According to some further embodiment of the invention the release information created in the service provider's system needs not to be delivered to the charging station 100. In such an embodiment the service provider's system is configured to create the release code and store it. The storage can be arranged in the service provider's system, i.e. a server therein, or to any network node accessible by the service provider's system and the charging station 100 in question. Namely, as the release code is stored in a storage location accessible by the charging station 100, the verification of release information inserted by a user can be arranged so that the charging station 100 is configured to deliver the inserted information to a predetermined network element, such as a network node and/or service provider's information system 610, for verification. In response to the verification process the entity performing the verification may deliver an acceptance message back to the charging station 100 if the release code is acceptable. In response to the acceptance message the charging station 100 may release at least one mobile terminal 140 for use.

Another use case may be that the service provider is a hotel. When the guest registers to the hotel, a room key is given to the guest. The room key is typically a magnetic card. The magnetic card may also be configured to carry information on the right to release a mobile terminal 140 from a charging station 100 locating in a hotel lobby, for example. The information on the room keys having the right to release a mobile terminal from the charging station 100 is also provided to the charging station 100. The provision can be implemented by arranging a necessary communication of the hotel key management system and the charging station. For example, the information on the keys having the right to release the mobile terminal 140 from the charging station 100 may be transmitted to a memory unit 320 of the charging station 100 accessible to the processing unit 310 of the charging station 100. Alternatively or in addition, the information on the rights belonging to a certain key may be stored in the service provider's information system, such as hotel key management system or a similar system, which information is accessible by the charging station 100 when needed. Now, the hotel guest may go and insert the room key to a card reader implemented in the charging station 100. The charging station 100 is configured to identify the key and check the rights belonging to the key from the internal memory or request the information from an external system, such as the key management system. If the access verification is positive, the charging station is configured to release a mobile terminal 140 for use. Generally speaking the idea belonging to the coverage of the present invention is that information relating to user access rights to at least one mobile terminal 140 residing in the charging station 100 may be stored in the information system 610. By means of the information it is possible to release at least one mobile terminal 140 for use if the user provides such information, like allowing reading of information from the hotel key card, in the charging station 100.

Further, the service provider's information system 610 may be configured to monitor the activity of the radio channels between the charging station 100 and the at least one mobile terminal 140 as described above. The monitoring of the theft may also be implemented in the information system 610 as well as maintenance of the location information of the mobile terminals 140. It may also be arranged that either the information system 610 or the charging station 100 may be configured to create and initiate a delivery an inactivation signal to the mobile terminal 100 in order to prevent a misuse of the mobile terminal 100.

According to further embodiment of the invention the maintenance of the at least one mobile terminal 140 may be arranged through the charging station 100. For example, the software updates and similar information can be delivered to the mobile terminals 140 though the communication channels arranged for the charging station 100.

In case of the availability of more than one mobile terminal 140 for the user in the charging station 100 it may be convenient to release the mobile station 140 having the most charged battery. In order to achieve this measurement apparatus is implemented to each of the charging locations 110. Now, when a user enters acceptable release information to the charging station 100, the charging station 100, and especially the processing unit 310 of the charging station 100, is configured to compare the voltage level of the batteries in each of the mobile terminals 140 mounted in the charging station 100 at that point of time. The voltage levels of the batteries may be monitored continuously or they can be read when legitimate release information is inputted. In order to receive a reliable measurement result the charging station 100 may cease the current to enter to the battery under measurement and perform the voltage measurement of the battery. The same measurement procedure is performed to batteries of each of the mobile terminals 140 residing in the charging locations 110. Further, the processing unit 310 is configured to receive the voltage levels of the each of the batteries and compare them together. In response to the comparison, the processing unit 310 of the charging station 100 is configured to define the battery, and thus the mobile terminal 140, in which the voltage level is the highest. In response to the determination of the highest voltage level the charging station 100 is configured to release a mobile terminal 140 with the highest battery level by creating and delivering a release signal to the locking mechanism of the corresponding charging location 110. The released mobile terminal 140 may be indicated with indication means, such as a light source or a sound, or if the charging location is equipped with a mechanism to lift up the released mobile terminal 140, the charging station 100 may be configured to show the release by lifting up the terminal. The measurement of the charging of the battery may be performed with a voltage meter either implemented in each of the charging locations 110 or with one voltage meter, which is coupled either directly or indirectly to terminals of the batteries so that the voltage level of each of the batteries can be measured.

According to still some further embodiment of the invention the charging station 100 does not comprise I/O means 130, but the release information may be given through the mobile terminal 140 removably coupled to the charging location 110 in the charging station 100. The mobile terminal 140 may be configured to prompt release information, which is conveyed to the charging station 100 for verification. If the release information is verified, the charging station 100 is configured to release the locking mechanism for enabling the user of the mobile terminal 140. The input of information with the mobile terminal 140 can be enabled by e.g. touch screen of the mobile terminal 140.

The description above covers a charging station 100 comprising multiple features in order to provide a full turnkey system for service provider, who is willing to offer mobile terminals 140 for use to customers. Beforehand it may be difficult for the service provider to estimate the size of the charging station 100 and thus, how many mobile terminals 140 shall be enough to the customer base of the service provider. Thus, according to still some embodiments of the invention it can be arranged a modular charging station 100. With a modular charging station 100 it is meant that it is possible to couple blocks comprising one or more charging locations 110 together so that the number of charging locations 110 can be increased if needed. In such an implementation each block comprises connectors for coupling the blocks together so that electricity and data may be transferred between the blocks. At least one block is equipped with necessary connections so that electricity can be carried to the charging station 100 from the mains and also at least one block may comprise I/O means for inputting the release information by the user if required. As said, the release information may also be inputted via the mobile terminal 140. Further, at least one block is arranged to comprise processing unit and/or memory means as described.

Herein it is mainly described that the charging station 100 according to the invention comprises specific charging locations 110 for the mobile terminals 140 to be charged. However, it is possible to arrange so that the charging station 100 comprises one or more wires with a connector, which is configured to be mounted to a counter-connector in the mobile terminal 140. Furthermore, the connector is configured to be implemented so that the mobile terminal 140 can be locked to it either mechanically or electrically as already described. The release of the mobile terminals 140 can be arranged similarly as described above.

The charging of the mobile terminal 140 shall be understood to mean the charging of the battery of the mobile terminal 140. The charging station 100 comprises such a charging interface that the battery of the mobile terminal 140 can either be directly charged or indirectly through electrical interface of the mobile terminal 140.

Some advantageous embodiments according to the invention were described above. The invention is not limited to the embodiments described. The inventive idea can be applied in numerous ways within the scope defined by the claims attached hereto.

1. A charging station (100) for charging at least one mobile terminal (140) removably coupled to at least one charging location (110) of the charging station (100), comprising:
charging interface within the charging location (110) configured to provide current to a battery of the at least one mobile terminal (140),
locking mechanism configured to removably locking the at least one mobile terminal (140) with the charging station (100),
I/O means (130) configured to receive input comprising release information for releasing the at least mobile terminal (140) from the charging station (100),
processing unit (310) configured to verify if the inputted release information corresponds to legitimate release information available for the charging station (100), and if the verification indicates that the inputted release information corresponds to the legitimate release information, to deliver a release signal to the locking mechanism for releasing the locking of the at least one mobile terminal (140) with the charging station (100).

2. A charging station (100) according to the claim 1, wherein the legitimate release information available for the charging station (100) is stored in a memory unit (320).

3. A charging station (100) according to the claim 1, wherein the locking of the at least one mobile terminal (140) is arranged to be achieved mechanically.

4. A charging station (100) according to the claim 1, the charging station (100) further comprising a signal path with the removably locked mobile terminal (140).

5. A charging station (100) according to claim 4, wherein an electrical locking of the at least one mobile terminal (140) is arranged by means of the signal path.

6. A charging station (100) according to the claim 5, wherein at least one of the following information is exchanged over the signal path: acknowledgement signal for indicating a legitimate release of the mobile terminal (140), activation signal for activating the operation of the mobile terminal (140), status signal.

7. A charging station (100) according to claim 1, the charging station (100) further comprising alarm means configured to trigger an alarm if the mobile terminal (140) is removed in an unauthorized manner from the charging station (100).

8. A charging station (100) according to claim 1, the charging station (100) further comprising a wireless modem for establishing a wireless communication channel with the at least one mobile terminal (140).

9. A charging station (100) according to claim 8, wherein the charging station (100) is configured to monitor at least one of the following: activity of a wireless channel between the charging station (100) and at least one mobile terminal (140), signal strength of a wireless channel.

10. A charging station (100) according to claim 9, wherein the charging station (100) is configured to trigger an alarm if a predetermined condition is not met as regards to the activity of a wireless channel between the charging station (100) and at least one mobile terminal (140) or signal strength of a wireless channel.

11. A charging station (100) according to claim 1, the charging station (100) further comprising a wired or wireless modem for coupling the charging station (100) to an external entity with a corresponding communication technique.

12. A charging station (100) according to claim 1, the charging station (100) further comprising at least one voltage meter for measuring the charging of a battery of at least one mobile terminal (140) either continuously or in response to an input of legitimate release code.

13. A charging station (100) according to claim 12, wherein the processing unit (310) is configured to receive voltage levels of the batteries of at least two mobile terminals (140), to compare the voltage levels and in response to the comparison, the processing unit (310) of the charging station (100) is configured to define the mobile terminal (140) in which the voltage level of the battery is the highest.

14. A charging station (100) according to claim 13, wherein the processing unit (310) is configured to deliver a release signal to the locking mechanism of a charging location (110) charging the mobile terminal (140) having the battery with the highest voltage level.

15. A charging station (100) according to claim 1, the charging station (100) further comprising indication means for indicating the at least one released mobile terminal (140).

16. A charging system for providing a charging of at least one mobile terminal (140) in the system, the system comprising
a charging station (100) providing a charging location (110) for at least one mobile terminal (140) and removably locking the at least one mobile terminal (140) thereto, the charging station (100) further comprising I/O means for inputting information by a user,
an information system (610) for creating at least part of the release information for releasing the at least one mobile terminal (140) from the charging station (100),
wherein the charging station (100) and the information system (610) are arranged to be coupled either directly or indirectly over an external entity (601) for enabling the communication between the charging station (100) and the information system (610), and
wherein the release information created in the information system (610) is arranged to be available for the charging station (100) for verifying if the inputted information by the user matches with the created release information, and if the verification indicates that the inputted information corresponds to the created release information, the system is configured to deliver a release signal to the locking mechanism of the charging station (100) for releasing the at least one mobile terminal (140) from the charging station (100).

17. A charging system according to claim 16, wherein the created release information is either delivered to the charging station (100) for storing or stored in the information system (610).

18. A charging system according to claim 16, wherein the charging station (100) is configured to inquiry the stored release information from the information system (610) in response to a receipt of information inputted by the user by I/O means of the charging station (100).

19. A charging system according to claim 1, wherein the information system (610) is configured to store information on user access rights to release at least one mobile station (140) from the charging station (100).
